(19) United States
(12) Patent Application Publication
(10) Pub. No.: US 2014/0366370 A1
(43) Pub. Date: Dec. 18, 2014

(54) ELECTRIC WIRES SETTING METHOD WITH JIG

(71) Applicant: Yazaki Corporation, Tokyo (JP)

(72) Inventor: Tetsuro TAKASAKI, Makinohara-shi (JP)

(73) Assignee: YAZAKI CORPORATION, Tokyo (JP)

(21) Appl. No.: 14/474,871

(22) Filed: Sep. 2, 2014

Related U.S. Application Data
(63) Continuation of application No. PCT/JP2013/058178, filed on Mar. 13, 2013.

(30) Foreign Application Priority Data
Mar. 13, 2012 (JP) 2012-055354

(51) Int. Cl. H01R 43/28

(52) U.S. Cl. CPC H01R 43/28
USPC 29/857

(57) ABSTRACT

An electric wire setting method for setting a plurality of electric wires by using a jig in an electric wire holding part includes setting the electric wire holding part on a positioning platform of the jig, inserting the electric wires in gaps between guide protrusion pieces of the jig to guide the electric wires in electric wire retention grooves of the electric wire holding part, and folding a lower portion of the electric wire holding part toward an upper face of an upper holding portion of the electric wire holding part to sandwich the electric wires between the lower portion and the upper portion.

### CROSS REFERENCE TO RELATED APPLICATIONS

This application is a continuation of PCT application No. PCT/JP2013/058178, which was filed on Mar. 13, 2013 based on Japanese Patent Application (No. 2012-055354) filed on Mar. 13, 2012, the contents of which are incorporated herein by reference.

### BACKGROUND OF THE INVENTION

1. Field of the Invention

The present invention relates to an electric wire setting method with jig that has a support function when a plurality of electric wires are set in an electric wire holding part.

2. Description of the Related Art

Traditionally, when a plurality of electric wires are press-contacted to press contact terminals, the plurality of electric wires are press-contacted to the press contact terminals in a state that part of the plurality of electric wires are aligned in the direction that the press contact terminals are arranged. In this case, an electric wire holding part which holds the part of the plurality of electric wires in an aligned state is necessary. The electric wire holding part, for example, has a plurality of electric wire retention grooves which are aligned on an electric wire attached face so that part of the plurality of electric wires are aligned and held, and a plurality of electric wire retention protrusions which are projected so that part of the upper ends of the groove faces of the electric wire retention grooves are extended upwards and which are aligned in the direction the electric wires are arranged. The electric wire holding part is provided in a housing which is attached to the press contact terminals, or a press contact cover which is attached to the housing while the plurality of electric wires are press to press contact blades of the press contact terminals at the same time (for example, refer to PTL 1).

For the electric wire press-contact type connector described in PTL 1, the electric wire holding part is provided in the press contact cover, and after the electric wires are temporarily set in the electric wire retention grooves, the plurality of electric wires are press-contacted at the same time to the press contact terminals in the housing by attaching the press contact cover to the housing in which the press contact terminals are fixed. Alternatively, by using a jig for supporting setting electric wires, the electric wires are temporarily set at positions where the electric wired are supported by adjacent upper end portions of the electric wire retention protrusions of the electric wire holding part which is provided in the housing, and by attaching the press contact cover to the housing, the plurality of electric wires are press-contacted at the same time to the press contact terminals in the housing.

PTL 1:JP-A-2005-332796

### SUMMARY OF THE INVENTION

However, in the electric wire press-contact type connector described in PTL 1, there is no description of the consideration that the pitch of the electric wire retention grooves of the jig for supporting setting electric wires becomes narrower with the downsizing of the housing. Thus, when the electric wire retention grooves are aligned with narrow pitches, the distance between the adjacent upper end portions of the electric wire retention protrusions, or the width of a so-called accepting portion becomes narrower, and the operation of setting the electric wires in the accepting portion becomes complicated. As a result, there is a problem that the plurality of electric wires cannot be easily set in the electric wire retention grooves.

The present invention is made in view of the above-mentioned situations, and an object of the invention is to provide a jig for supporting setting electric wires so that a plurality of electric wires is easily set in a plurality of electric wire retention grooves respectively even if the electric wire retention grooves are aligned with narrow pitches.

(1) According to an aspect of the invention, a jig is for setting electric wires which supports an operation of setting a plurality of electric wires in an electric wire holding part which has a plurality of electric wire retention grooves which are aligned so that part of the plurality of electric wires are aligned and held on an electric wire attached face, and a plurality of electric wire retention protrusions which are projected so that part of the upper ends of groove faces of the electric wire retention grooves are extended upwards to make it difficult for the electric wires to move away from the electric wire retention grooves and which are aligned in a direction in which the electric wires are arranged, and in which the projected upper end portions of adjacent electric wire retention protrusions form accepting portions of the electric wires.

The jig includes an electric wire guide portion that includes plate shaped guide base parts which are arranged near the electric wire holding part and along the direction in which the plurality of electric wires are arranged during the operation, and a plurality of guide protrusion pieces which are projected from an upper edge face of the plate shaped guide base parts, and a portion around base end portions of which, when viewed from a direction perpendicular to the direction in which the plurality of electric wires are arranged, overlaps the electric wire retention protrusions.

The plurality of guide protrusion pieces are formed so that the base end portions are formed at positions below the accepting portions, the distance between adjacent guide protrusion pieces at the upper end portions is larger than the distance between adjacent guide protrusion pieces at the base end portions, and the upper end portions are extended to positions above the projected upper end portions of the electric wire retention protrusions.

The electric wires are set in the electric wire holding part, the electric wires are inserted between the adjacent guide protrusion pieces, and guided to the accepting portions by the guide protrusion pieces.

(2) In the jig for supporting setting electric wires of (1) the electric wire guide portion is provided in pairs so that the electric wire holding part is sandwiched in the extending direction of the electric wires and the plate shaped guide base parts face each other.

(3) The jig for supporting setting electric wires of (1) or (2) further includes a positioning platform where the electric wire holding part and the electric wire guide portion are positioned and fixed.

(4) The jig for supporting setting electric wires of any one of (1) to (3) further includes a tension adjusting portion that adjusts the tension of the plurality of electric wires.

(5) According to another aspect of the invention, an electric wire setting method for setting a plurality of electric wires by using a jig in an electric wire holding part which includes:

a plurality of electric wire retention grooves which are aligned so that part of the plurality of electric wires are aligned and held on an electric wire attached face; and

a plurality of electric wire retention protrusions which are projected so that part of the upper ends of groove faces of the electric wire retention grooves are extended upwards to make it difficult for the electric wires to move away from the electric wire retention grooves and which are aligned in a direction in which the electric wires are arranged, and in which the projected upper end portions of adjacent electric wire retention protrusions form accepting portions of the electric wires, the jig including:

a positioning platform on which the electric wire holding part is set; and an electric wire guide portion that includes:
plate shaped guide base parts which are arranged near the electric wire holding part and along the direction in which the plurality of electric wires are arranged during the operation; and
a plurality of guide protrusion pieces which are projected from an upper edge face of the plate shaped guide base parts, and a portion around base end portions of which, when viewed from a direction perpendicular to the direction in which the plurality of electric wires are arranged, overlaps the electric wire retention protrusions,

wherein the plurality of guide protrusion pieces are formed so that the base end portions are formed at positions below the accepting portions, the distance between adjacent guide protrusion pieces at the upper end portions is larger than the distance between adjacent guide protrusion pieces at the base end portions, and the upper end portions are extended to positions above the projected upper end portions of the electric wire retention protrusions, and

when the electric wires are set in the electric wire holding part, the electric wires are inserted between the adjacent guide protrusion pieces, and guided to the accepting portions by the guide protrusion pieces, the method includes:

setting the electric wire holding part on the positioning platform of the jig;

inserting the electric wires in gaps between the guide protrusion pieces of the jig to guide the electric wires in the electric wire retention grooves of the electric wire holding part; and

folding a lower portion of the electric wire holding part toward an upper face of an upper holding portion of the electric wire holding part to sandwich the electric wires.

According to the jig for supporting setting electric wires of (1) and the electric wire setting method of (4), the plurality of guide protrusion pieces are so formed that the base end portions are located below the accepting portions, the distance between adjacent guide protrusion pieces at the upper end portions is larger than the distance between adjacent guide protrusion pieces at the base end portions, and the upper end portions are extended to positions above the projected upper end portions of the electric wire retention protrusions. Thus, the distance between the upper end portions of the guide protrusion pieces is wider than the distance between the electric wire retention protrusions at the accepting portions. Therefore, the electric wires is easily inserted between the adjacent guide protrusion pieces. The electric wires are easily guided to the accepting portions by the guide protrusion pieces. As a result, the plurality of electric wires is easily set into the electric wire retention grooves respectively even if the plurality of electric wire retention grooves are aligned with narrow pitches.

According to the jig for supporting setting electric wires of (2), the electric wire guide portion is provided in pairs so that the electric wire holding part is sandwiched in the extending direction of the electric wires, and the plate shaped guide base parts face each other. Thus, the electric wires is supported in two places that are spaced, and it becomes easier to guide the four electric wires in an aligned state. As a result, with the jig for supporting setting electric wires, the operation of setting the plurality of electric wires in the electric wire holding part is performed more easily.

According to the jig for supporting setting electric wires of (3), an operation of positioning the electric wire holding part and the electric wire guide portion is not necessary. With the jig for supporting setting electric wires, the operation of setting the plurality of electric wires in the electric wire holding part is performed more easily.

According to the jig for supporting setting electric wires of (4), the electric wires, whose tension is adjusted by the tension adjusting portion, is guided to the accepting portions by the guide protrusion pieces. With the jig for supporting setting electric wires, the operation of setting the plurality of electric wires in the electric wire holding part is performed more easily.

### BRIEF DESCRIPTION OF THE DRAWINGS

FIG. 1 is an exploded perspective view of a vehicle indoor illuminating lamp into which an electric wire holder, in which electric wires are set using a jig for supporting setting electric wires according to an embodiment of the present invention, is incorporated.

FIG. 2A is a perspective view in which an assembly, in which a lens and a bus bar is assembled to a housing shown in FIG. 1, is viewed from the side where the electric wire holder is assembled.

FIG. 2B is an enlarged view of FIG. 2A.

FIG. 3 is a figure which shows a state before an upper holding portion of the electric wire holder is overlaid on a lower holding portion of the electric wire holder shown in FIG. 1.

FIG. 4 is a figure in which the upper holding portion of the electric wire holder shown in FIG. 1 is viewed from the side where the upper holding portion is overlaid on the lower holding portion.

FIG. 5 is a side view of an area around the upper holding portion of the electric wire holder shown in FIG. 1.

FIG. 6 is a perspective view of the jig for supporting setting electric wires according to the present invention.

FIG. 7 is a figure which shows a state that the electric wire holder is set on the jig for supporting setting electric wires shown in FIG. 6.

FIG. 8 is a figure in which an area around an electric wire guide portion shown in FIG. 7 is viewed from above.

FIG. 9A is a figure in which an area around the electric wire guide portion shown in FIG. 7 is viewed from side, and FIG. 9B is a figure in which hidden lines of the electric wire holder are added to the upper figure.

FIG. 10 is an enlarged view which shows base end portions of a plurality of guide protrusion pieces shown in FIG. 9A.

FIGS. 11A and 11B are figures which show a procedure of setting four electric wires into the electric wire holder.

FIGS. 12A and 12B are figures which show a procedure of setting the four electric wires into the electric wire holder.

FIGS. 13A and 13B are figures which show a procedure of setting the four electric wires into the electric wire holder.

FIGS. 14A to 14C are figures which show a procedure of connecting the four electric wires which are partly held by the electric wire holder to press contact terminals.

FIG. 15 is a perspective view which shows a jig for supporting setting electric wires of a modified embodiment 1.

FIG. 16 is a perspective view which shows a jig for supporting setting electric wires of a modified embodiment 2.

### DETAILED DESCRIPTION OF THE EXEMPLARY EMBODIMENTS

Preferred embodiments of the jigs for supporting setting electric wires according to the present invention will be described in detail with reference to the figures as follows.

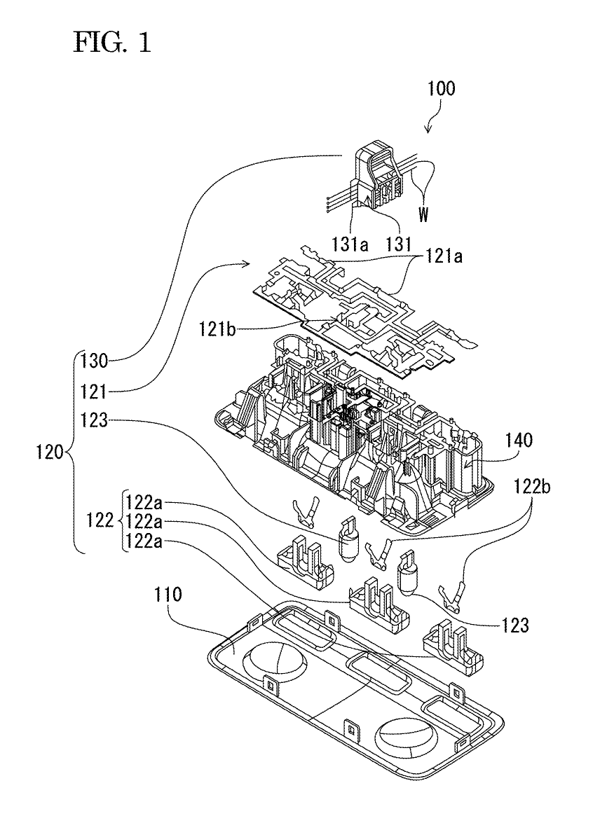

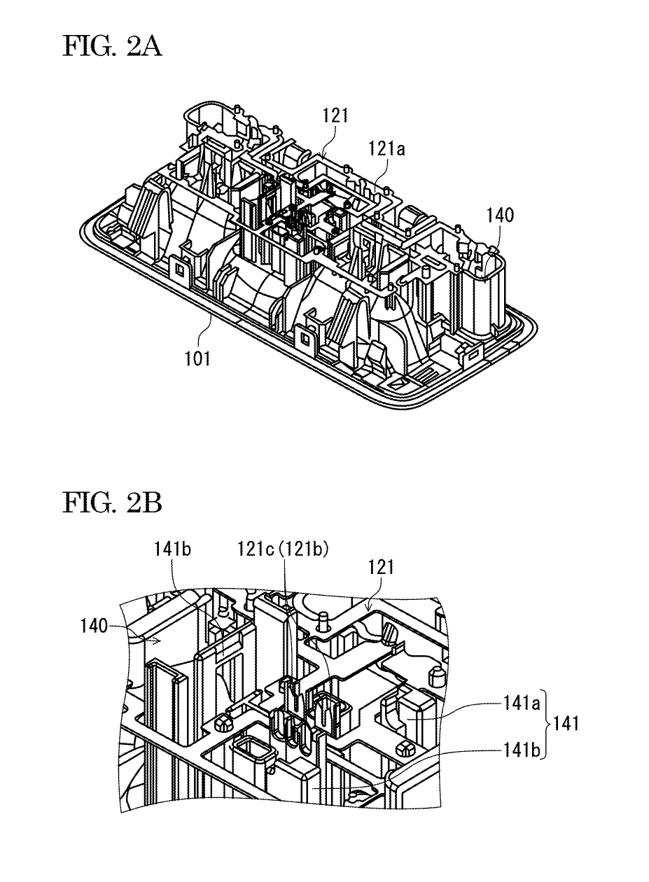

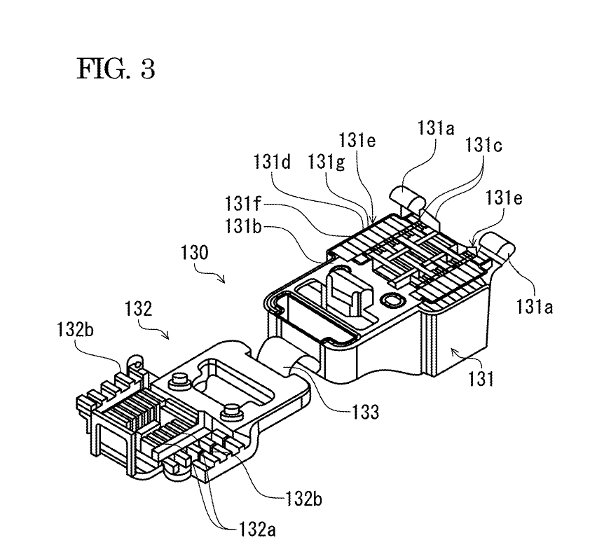

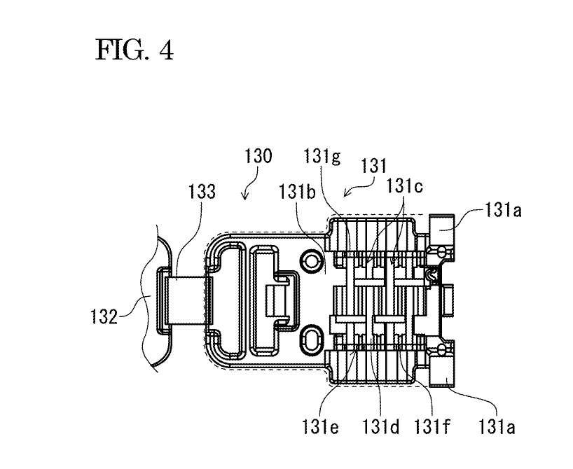

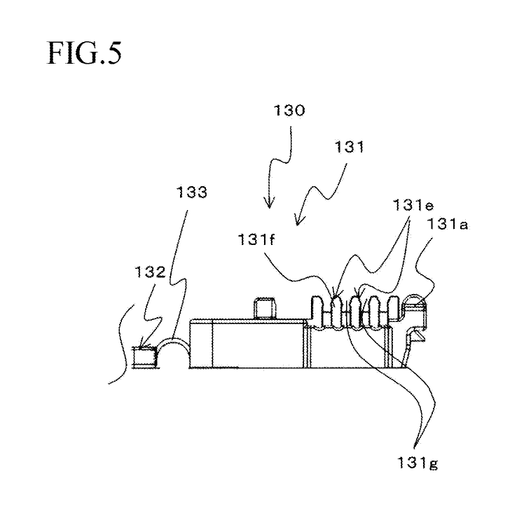

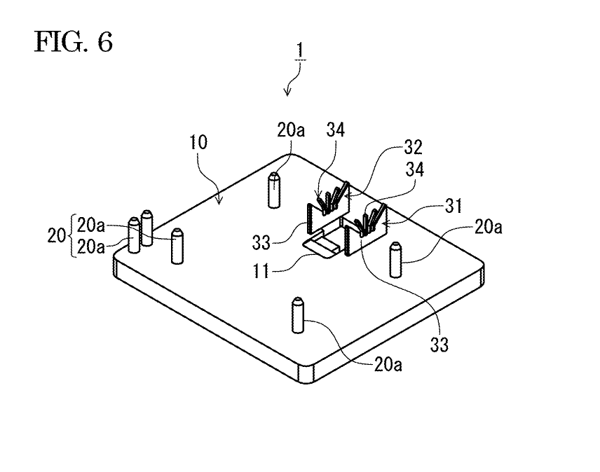

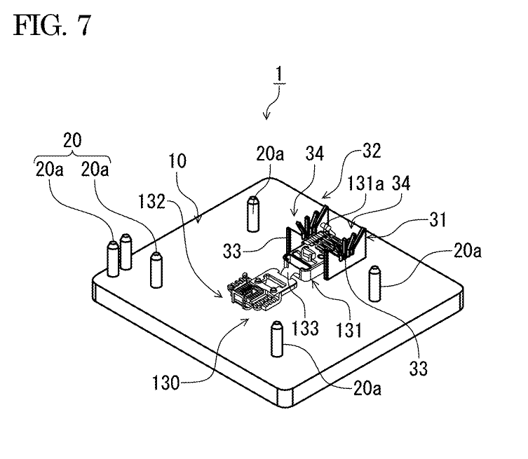

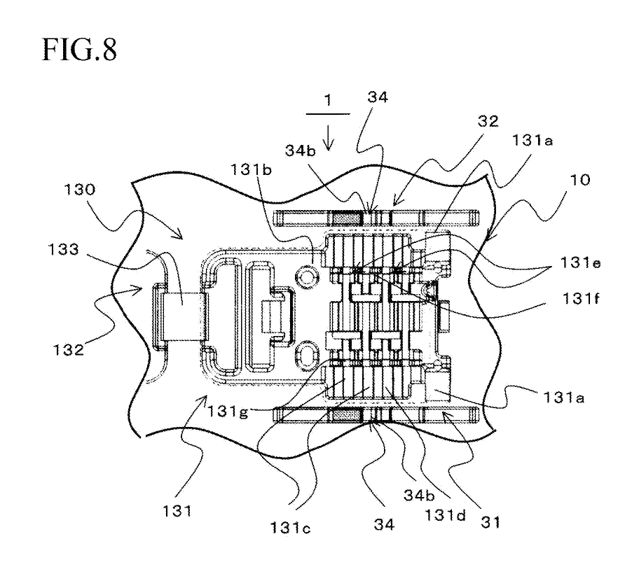

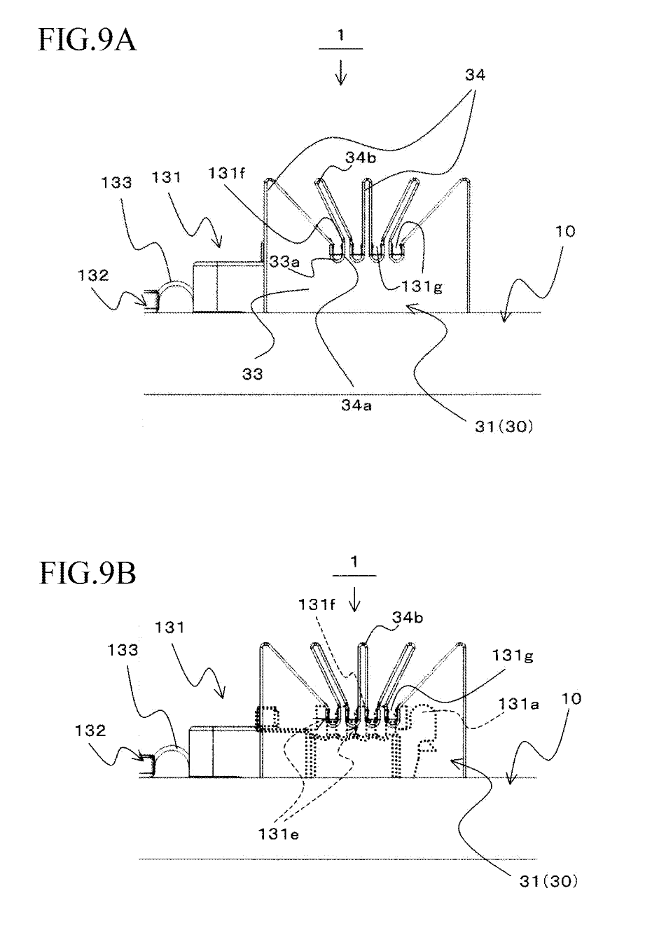

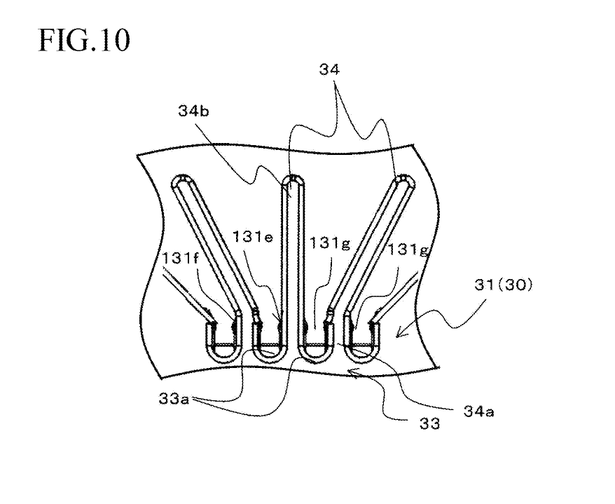

FIG. 1 is an exploded perspective view of a vehicle indoor illuminating lamp 100 into which an electric wire holder 130, in which electric wires W are set using a jig for supporting setting electric wires 1 according to an embodiment of the present invention, is incorporated. FIG. 2A is a perspective view in which an assembly, in which a lens 110 and a bus bar 121 is assembled to a housing 140 shown in FIG. 1, is viewed from the side where the electric wire holder 130 is assembled. FIG. 2B is an enlarged view of an area around an electric wire holder attached portion 141 in the upper figure. FIG. 3 is a figure which shows a state before an upper holding portion 131 of the electric wire holder 130 is overlaid on a lower holding portion 132 of the electric wire holder 130 shown in FIG. 1. FIG. 4 is a figure in which the upper holding portion 131 of the electric wire holder 130 shown in FIG. 1 is viewed from the side where the upper holding portion 131 is overlaid on the lower holding portion 132. FIG. 5 is a side view of an area around the upper holding portion 131 of the electric wire holder 130 shown in FIG. 1. FIG. 6 is a perspective view of the jig for supporting setting electric wires 1 according to the present invention. FIG. 7 is a figure which shows a state that the electric wire holder 130 is set on the jig for supporting setting electric wires 1 shown in FIG. 6. FIG. 8 is a figure in which an area around an electric wire guide portion shown in FIG. 7 is viewed from above. FIG. 9A is a figure in which an area around the electric wire guide portion 30 shown in FIG. 7 is viewed from side, and FIG. 9B is a figure in which hidden lines of the electric wire holder 130 are added to the upper figure. FIG. 10 is an enlarged view which shows base end portions 34a of a plurality of guide protrusion pieces 34 shown in FIG. 9A.

The jig for supporting setting electric wires 1 according to the embodiment of the present invention, for example, is used when the electric wires W are set on the electric wire holder 130 which is assembled into the vehicle indoor lamp 100.

First, the construction of the vehicle indoor lamp 100 is described, and then the jig for supporting setting electric wires 1 is described.

The vehicle indoor lamp 100 includes the lens 110, a lighting function portion 120, and the housing 140 which is used as a base of the vehicle indoor lamp 100 and to which the lens 110 and the lighting function portion 120 are assembled.

The lens 110 is a board-like member made of light-permeable material, collects light emitted from bulbs 123 of the lighting function portion 120, and allows the light to pass to the outside of the housing 140.

The lighting function portion 120 is a function portion of the vehicle indoor lamp 100, and includes a bus bar 121, a switch operation portion 122, the bulbs 123 and an electric wire holder 130.

The bus bar 121 includes power supply terminals 121a and four press contact terminals 121b which have press contact blades 121c to connect the electric wires W.

In this embodiment, it is exemplified that the number of the electric wires W is four, but the number of the electric wires W is not limited to four. The number of the press contact terminals 121b is also not limited, and is set according to the number of the electric wires W.

The switch operation portion 122 is an operation portion for switching ON/OFF the bulbs 123, and includes three switches 122a to switch among three modes. The switches 122a are accommodated in the housing 140. The switch operation portion 122 is connected to the power supply terminals 121a of the bus bar 121 through contacts 122b so that the bulbs 123 may be electrified.

In order to press-contact part of the four electric wires W to the press contact terminals 121b which are provided in the housing 140, the electric wire holder 130, as a portion separate from the housing 140, holds part of the four electric wires W, and is assembled while pivoting around rotation shafts 131a which are supported by a rotation support portion 141a.

In particular, in the electric wire holder 130, as shown in FIGS. 3 to 5, the upper holding portion 131 and the lower holding portion 132 are coupled through a joint 133 which may be bent. While the joint 133 is bent, the plurality of electric wires W are sandwiched between the upper holding portion 131 and the lower holding portion 132 so that the four electric wires W are held.

The upper holding portion 131, as an electric wire holding portion, includes the rotation shafts 131a, four electric wire retention grooves 131c which are aligned on an electric wire attached face 131b in order to hold the four electric wires W, and a plurality of electric wire retention protrusions 131e which are projected so that part of the upper ends of groove faces 131d of the electric wire retention grooves 131c are extended upwards to make it difficult for the electric wires W to move away from the electric wire retention grooves 131c, and which are aligned in the direction the electric wires W are arranged. Adjacent projected upper end portions 131f of the electric wire retention protrusions 131e become accepting portions for the electric wires.

The electric wire holder in this embodiment is so provided that the electric wire retention protrusions 131e are aligned in the direction the electric wires W are arranged at two end portions of the electric wire retention grooves 131c.

The rotation shafts 131a have a cylindrical shape which has a semicircular cross-section, and are provided near an end portion of the upper holding portion 131.

The lower holding portion 132 has a plurality of lower holding portion side electric wire retention grooves 132a which are formed to fit with the electric wire retention grooves 131c, when the joint 133 is bent so that the lower holding portion is overlaid on the upper holding portion 131, to hold the electric wires W, and a press contact blade penetrating portion 132b which is formed so that the lower holding portion 132 is penetrated when the press contact blades 121c press-contact the part where the electric wires are held in the electric wire holder 130.

The housing 140 includes the electric wire holder attached portion 141 which becomes a portion where the electric wire holder 130 is assembled. As shown in FIG. 2, the electric wire holder attached portion 141 has the rotation support portion 141a which rotatably supports the rotation shafts 131a of the electric wire holder 130, and a lock portion 141b which abuts with the electric wire holder 130 to fix the electric wire holder 130 at an assembled position.

Next, the jig for supporting setting electric wires 1 is described.

As shown in FIGS. 6 and 7, the jig for supporting setting electric wires 1 includes a positioning platform 10 where the positions of the upper holding portion 131 of the electric wire holder 130 and an electric wire guide portion 30 to be described below are fixed, a tension adjusting portion 20 which adjusts the tension of the electric wires W, and the electric wire guide portion 30 which guides the four electric wires W to the accepting portions 131g of the electric wire holder 130.

The positioning platform 10 has an electric wire holder set portion 11 which includes openings, steps and the like which are formed in accordance with the external shape of the electric wire holder 130 to fix the electric wire holder 130 at a predetermined position on the positioning platform 10. The electric wire holder 130 is fixed between a first electric wire guide portion 31 and a second electric wire guide portion 32 to be described below in a state that the upper holding portion 131 is not overlaid on the lower holding portion 132 and the electric wire retention protrusions 131e of the upper holding portion 131 face upwards.

The tension adjusting portion 20 adjusts the tension of the electric wires W so that the four electric wires W are easily guided to the accepting portions 131g by the electric wire guide portion 30.

The tension adjusting portion 20 has columnar protrusions 20a which are spaced and raised at six positions on the positioning platform 10. The tension of the electric wires W is adjusted by bending the electric wires W around the columnar protrusions 20a.

The electric wire guide portion 30 has a first electric wire guide portion 31 and a second electric wire guide portion 32 which are arranged to sandwich the upper holding portion 131 of the electric wire holder 130, which is set on the positioning platform 10, and face each other.

The first electric wire guide portion 31 and the second electric wire guide portion 32 have the same shape, and each has a plate shaped guide base part 33 and five guide protrusion pieces 34.

The plate shaped guide base parts 33 are board-like parts which are arranged near the upper holding portion 131 of the electric wire holder 130 and along the direction the four electric wires W.

The five guide protrusion pieces 34 are projected from the upper edge face 33a of the plate shaped guide base part 33, and are projected so that the areas around base end portions 34a, when viewed from the direction perpendicular to the direction the four electric wires W are arranged, overlap with the electric wire retention protrusions 131e.

The guide protrusion pieces 34 are so formed that the base end portions 34a are located below the accepting portions 131a, the distance between adjacent guide protrusion pieces 34 at upper end portions 34b is larger than the distance between adjacent guide protrusion pieces 34 at the base end portions 34a, and the upper end portions 34b are extended to positions above the projected upper end portions 131f of the electric wire retention protrusions 131e.

With such an electric wire guide portion 30, when the electric wires W are set on the electric wire holder 130, the electric wires W are inserted between the adjacent guide protrusion pieces 34 of the first electric wire guide portion 31 and the second electric wire guide portion 32 respectively, and are guided to the accepting portions 131g by the guide protrusion pieces 34 of the first electric wire guide portion 31 and the second electric wire guide portion 32.

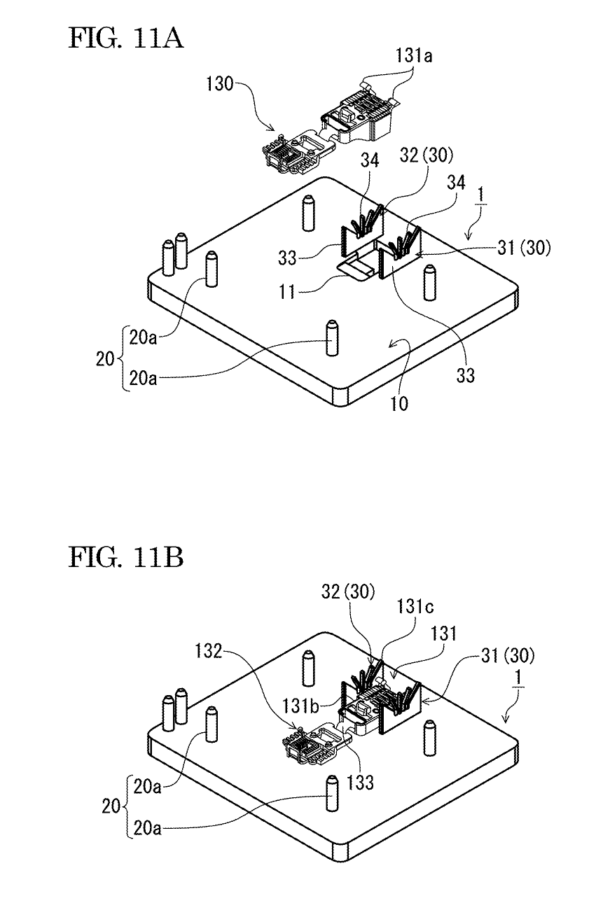

Next, a procedure of setting the four electric wires W into the electric wire holder 130 is described by using FIGS. 11A to 13B. FIGS. 11A to 13B are figures which show the procedure of setting the four electric wires W into the electric wire holder 130.

First, an operator sets the electric wire holder 130 on the positioning platform 10 (refer to FIGS. 11A and 11B). Thereby, the upper holding portion 131 of the electric wire holder 130 is fixed between the first electric wire guide portion 31 and the second electric wire guide portion 32 in a state that the electric wires W can be set into the accepting portions 131g from above.

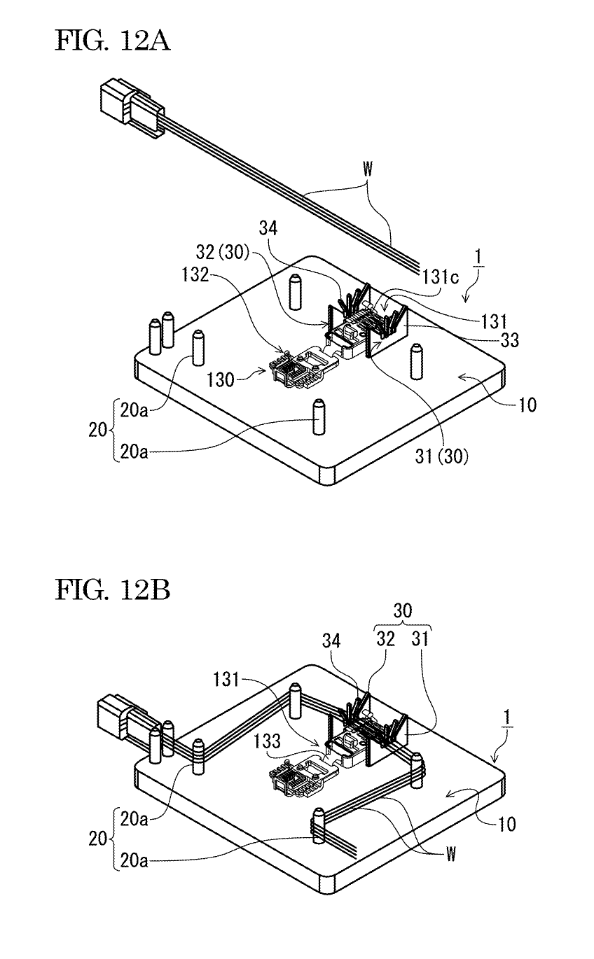

Then the operator draws the four electric wires W around the columnar protrusions 20a, and inserts the electric wires W between the guide protrusion pieces 34 of the first electric wire guide portion 31 and the second electric wire guide portion 32 (refer to FIGS. 12A and 12B). For the first electric wire guide portion 31 and the second electric wire guide portion 32, the distance between the adjacent guide protrusion pieces 34 at the upper end portions 34b is larger than the distance between the adjacent guide protrusion pieces 34 at the base end portions 34a. That is, the distance between the upper end portions 34b of the guide protrusion pieces 34 is wider than the distance between the electric wire retention protrusions 131e at the accepting portions 131g. Therefore, the electric wires W are easily inserted between the adjacent guide protrusion pieces 34. Because the base end portions 34a of the guide protrusion pieces 34 are formed at positions below the accepting portions 131g, the electric wires W are guided to the accepting portions 131g by the guide protrusion pieces 34.

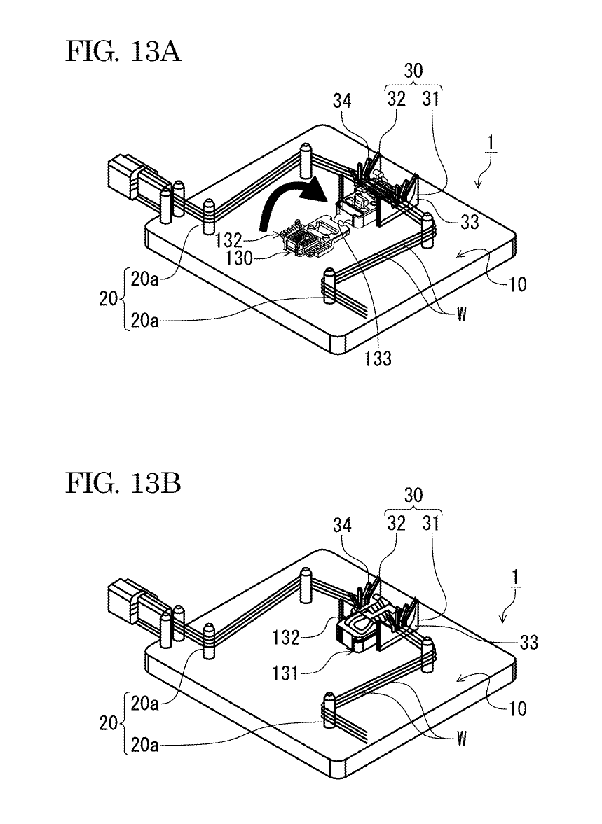

Then, the operator folds the lower holding portion 132 of the electric wire holder 130 towards the side of the upper holding portion 131 to sandwich the four electric wires W (refer to FIGS. 13A and 13B). Thereby, the operation of setting the four electric wires W in the electric wire holder 130 is completed. That is, the four electric wires W are partly fitted in the electric wire retention grooves 131c, and are aligned and held on the electric wire attached face 131b of the upper holding portion 131.

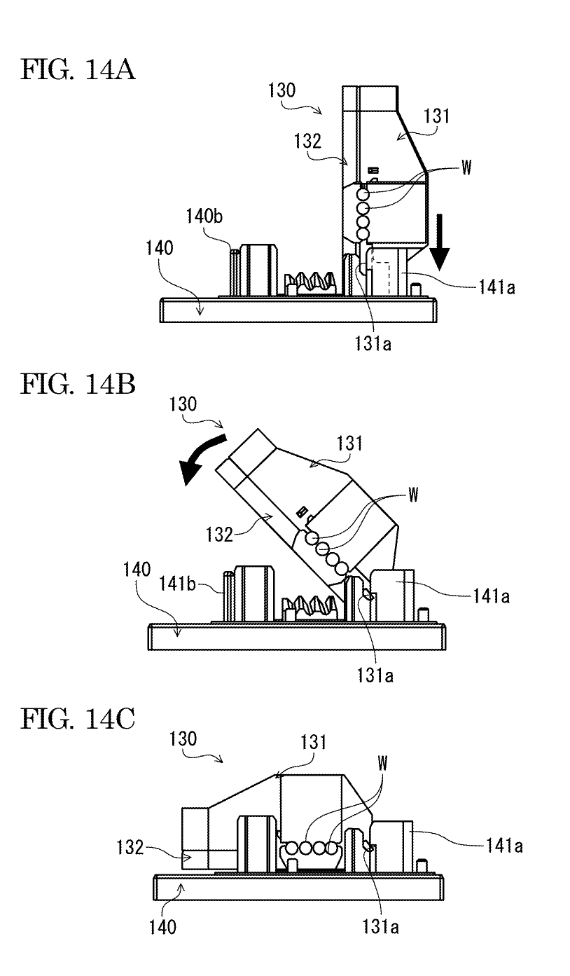

When the four electric wires W which are partly held by the electric wire holder 130 are connected to the press contact terminals 121b, the electric wire holder 130 is assembled to the housing 140 as shown in FIGS. 14A to 14C. FIGS. 14A to 14C are figures which show a procedure of connecting the four electric wires W which are partly held by the electric wire holder 130 to the press contact terminals 121b.

In particular, the operator sets the rotation shafts 131a of the electric wire holder 130 on the rotation support portion 141a of the housing 140 (refer to FIG. 14A), and then makes the electric wire holder 130 to be pivoted around the rotation shafts 131a (refer to FIG. 14B) and fixed to the housing 140 by the lock portion 141b at an assembled position of the electric wire holder 130 (refer to FIG. 14C). Thereby, the electric wires W held by the electric wire holder 130 are press-contacted to the press contact terminals 121b.

In the jig for supporting setting electric wires 1 according to the embodiment of the present invention, the plurality of guide protrusion pieces 34 are so formed that the base end portions 34a are located below the accepting portions 131g, the distance between adjacent guide protrusion pieces 34 at the upper end portions 34b is larger than the distance between adjacent guide protrusion pieces 34 at the base end portions 34a, and the upper end portions 34b are extended to positions above the projected upper end portions 131f of the electric wire retention protrusions 131 e. Thus, the distance between the upper end portions 34b of the guide protrusion pieces 34 is wider than the distance between the electric wire retention protrusions 131e at the accepting portions 131g. Therefore, the electric wires W is easily inserted between the adjacent guide protrusion pieces 34, and the electric wires W are easily guided to the accepting portions 131g by the guide protrusion pieces 34. As a result, the plurality of electric wires W is easily set into the electric wire retention grooves 131c respectively even if the plurality of electric wire retention grooves 131c are aligned with narrow pitches.

In the jig for supporting setting electric wires 1 according to the embodiment of the present invention, the electric wire guide portion 30 is provided in pairs so that the upper holding portion 131, which is used as the electric wire holding part, is sandwiched in the extending direction of the electric wires W, and the plate shaped guide base parts 33 of the first electric wire guide portion 31 and the second electric wire guide portion 32 face each other. Thus, the electric wires W is supported in two places that are spaced, and it becomes easier to guide the four electric wires Win an aligned state. As a result, with the jig for supporting setting electric wires 1, the operation of setting the four electric wires W in the upper holding portion 131 is performed more easily.

Moreover, with the jig for supporting setting electric wires 1 according to the embodiment of the present invention, an operation of positioning the upper holding portion 131 and the electric wire guide portion 30 is not necessary. Therefore, with the jig for supporting setting electric wires 1, the operation of setting the four electric wires W in the upper holding portion 131 is performed more easily.

With the jig for supporting setting electric wires 1 according to the embodiment of the present invention, the electric wires W, whose tension is adjusted by the tension adjusting portion 20, is guided to the accepting portions 131g by the guide protrusion pieces 34. Therefore, with the jig for supporting setting electric wires 1, the operation of setting the four electric wires W in the upper holding portion 131 is performed more easily.

### Modified Embodiment 1

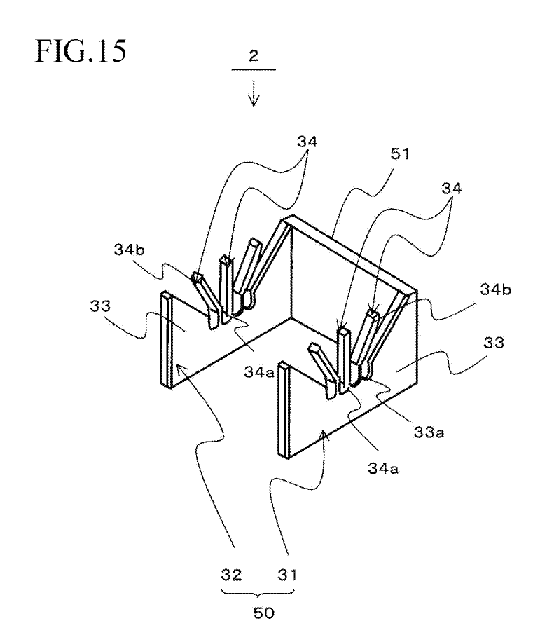

Then, a modified embodiment 1 of the jig for supporting setting electric wires 1 according to the embodiment of the present invention is described by using FIG. 15. FIG. 15 is a perspective view which shows the jig for supporting setting electric wires 2 of the modified embodiment 1.

The jig for supporting setting electric wires 2 of the modified embodiment 1 differs from the jig for supporting setting electric wires 1 in the embodiment in that the jig for supporting setting electric wires 2 is constructed only by an electric wire guide portion 50 which is a portion separate from the positioning platform 10.

In addition, other components are the same as those of the embodiment, and the same symbols as those of the same component of the embodiment are given.

In the electric wire guide portion 50, a first electric wire guide portion 31 and a second electric wire guide portion 32 are connected integrally by an integral joint portion 51.

With the jig for supporting setting electric wires 2, when the upper holding portion 131 of the electric wire holder 130, which is fixed on a positioning platform that is not shown in the figure and is separate from the jig for supporting setting electric wires 2, is positioned and fixed on the positioning platform not shown to be located between the first electric wire guide portion 31 and the second electric wire guide portion 32, the electric wires W are guided to the accepting portions 131g like the above embodiment.

Like the jig for supporting setting electric wires 1 in the above embodiment, with the jig for supporting setting electric wires 2 of the modified embodiment 1, the four electric wires W is easily set into the electric wire retention grooves 131c respectively even if the plurality of electric wire retention grooves 131c are aligned with narrow pitches.

### Modified Embodiment 2

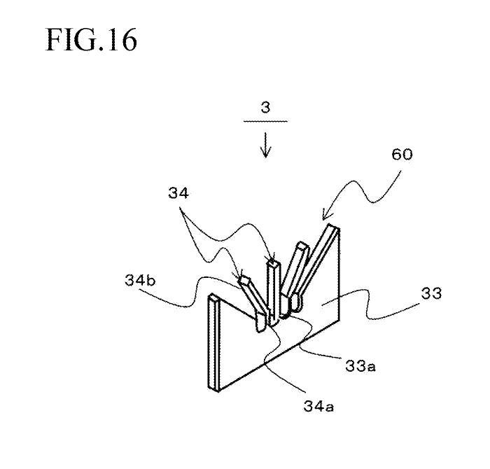

Then, a modified embodiment 2 of the jig for supporting setting electric wires 1 according to the embodiment of the present invention is described by using FIG. 16. FIG. 16 is a perspective view which shows the jig for supporting setting electric wires 3 of the modified embodiment 2.

The jig for supporting setting electric wires 3 of the modified embodiment 2 differs from the jig for supporting setting electric wires 1 in the embodiment in that an electric wire guide portion 60 is provided separately from the positioning platform to which the electric wire holder 130 is positioned and fixed, and that the electric wire guide portion 60 is constructed by either of the first electric wire guide portion 31 and the second electric wire guide portion 32.

In addition, other components are the same as those of the embodiment, and the same symbols as those of the same component of the embodiment are given. The electric wire guide portion 60 is used, for example, when terminal parts of the electric wires W are held by the electric wire holder 130.

Like the jig for supporting setting electric wires 1 in the above preferred embodiment, with the jig for supporting setting electric wires 3 of the modified embodiment 2, the four electric wires W is be easily set into the electric wire retention grooves 131c respectively even if the plurality of electric wire retention grooves 131c are aligned with narrow pitches.

In addition, in the jigs for supporting setting electric wires 1, 2 and 3 according to the embodiments of the present invention, it is exemplified that the electric wire holding part is the upper holding portion 131 of the electric wire holder 130, but the invention is not limited to this. Other electric wire holding parts may be used as long as the plurality of electric wire retention grooves which are aligned so that part of the plurality of electric wires W are aligned and held on the electric wire attached face, and the plurality of electric wire retention protrusions which are projected so that part of the upper ends of the groove faces of the electric wire retention grooves are extended upwards to make it difficult for the electric wires W to move away from the electric wire retention grooves, and which are aligned in the direction the electric wires W are arranged are included, and the projected upper end portions of the adjacent electric wire retention protrusions become the accepting portions of the electric wires W.

The invention accomplished by the inventor is described in detail based on the above embodiment of the invention, but the present invention is not limited to the above embodiment of the invention and may be modified in various ways without departing from the spirit of the invention.

There is provided a jig for supporting setting electric wires capable of easily setting a plurality of electric wires in a plurality of electric wire retention grooves respectively even if the electric wire retention grooves are aligned with narrow pitches.

What is claimed is:

1. An electric wire setting method for setting a plurality of electric wires by using a jig in an electric wire holding part which includes:
a plurality of electric wire retention grooves which are aligned so that part of the plurality of electric wires are aligned and held on an electric wire attached face; and
a plurality of electric wire retention protrusions which are projected so that part of the upper ends of groove faces of the electric wire retention grooves are extended upwards to make it difficult for the electric wires to move away from the electric wire retention grooves and which are aligned in a direction in which the electric wires are arranged, and in which the projected upper end portions of adjacent electric wire retention protrusions form accepting portions of the electric wires, the jig including:
a positioning platform on which the electric wire holding part is set; and
an electric wire guide portion that includes:
plate shaped guide base parts which are arranged near the electric wire holding part and along the direction in which the plurality of electric wires are arranged during the operation; and
a plurality of guide protrusion pieces which are projected from an upper edge face of the plate shaped guide base parts, and a portion around base end portions of which, when viewed from a direction perpendicular to the direction in which the plurality of electric wires are arranged, overlaps the electric wire retention protrusions,
wherein the plurality of guide protrusion pieces are formed so that the base end portions are formed at positions below the accepting portions, the distance between adjacent guide protrusion pieces at the upper end portions is larger than the distance between adjacent guide protrusion pieces at the base end portions, and the upper end portions are extended to positions above the projected upper end portions of the electric wire retention protrusions, and
when the electric wires are set in the electric wire holding part, the electric wires are inserted between the adjacent guide protrusion pieces, and guided to the accepting portions by the guide protrusion pieces, the method comprising:
setting the electric wire holding part on the positioning platform of the jig;
inserting the electric wires in gaps between the guide protrusion pieces of the jig to guide the electric wires in the electric wire retention grooves of the electric wire holding part; and
folding a lower portion of the electric wire holding part toward an upper face of an upper holding portion of the electric wire holding part to sandwich the electric wires between the lower portion and the upper portion.
